(19) United States
(12) Patent Application Publication
(10) Pub. No.: US 2016/0330945 A1
(43) Pub. Date: Nov. 17, 2016

(54) LURE WEIGHTS AND METHODS OF USING THE SAME

(71) Applicant: CLAM CORPORATION, Rogers, MN (US)

(72) Inventor: Bruce Mosher, Beltrami, MN (US)

(21) Appl. No.: 14/710,259

(22) Filed: May 12, 2015

(51) Int. Cl. A01K 85/01; A01K 99/00; A01K 95/00; A01K 85/00

(52) U.S. Cl. CPC A01K 85/01; A01K 85/00; A01K 99/00; A01K 95/00

(57) ABSTRACT

A lure weight including a body having a mass, a connector that extends from the body, and the connector having a proximal portion connected to the body and a distal portion comprising a releasable clip is disclosed. Also disclosed are methods of connecting such a lure weight to a lure and methods of fishing when using such a lure weight.

### BACKGROUND OF THE INVENTION

1. Field of the Invention

The present invention generally relates to fishing and fishing lures, and more particularly to weights for fishing lures and methods of using the weights to control the motion of fishing lures.

2. Discussion of the Prior Art

Many varieties of fishing lures have been in use for years and they tend to be designed for use in particular settings, with specific action and to attract and catch various species of fish. Often lures are designed as artificial bait lures to attract fish while the lures move through the water, as opposed to while floating on the surface. Some lures are referred to as crank baits, crank lures, or crank bait lures because they are designed to be pulled through the water, such as when cranking the fishing line onto a reel, after casting the lure on the fishing line, or when trolling with the lure behind a moving boat. It is quite common for such lures to be buoyant, so as to float, and they may be configured to dive, as if swimming, when the fishing line to which the lure is connected is pulled. For instance, crank bait lures typically are designed for fishing in a moving boat or when an angler is casting and retrieving the lure. As such, they may be referred to as diving lures and such lures are not designed or known to be used for fishing within one area of water immediately near an angler, which will be referred to herein generally as a vertical column of water, such as when fishing along the side of a boat, or in the more extreme situation presented when ice fishing. Indeed, drilling a hole through ice and then watching a crank bait lure or other buoyant lure simply float within the hole would not be productive. As a result, anglers traditionally put away their crank bait lures and buoyant lures generally during the ice fishing season.

In terms of their configuration, artificial bait lures often include a figure or central physical structure that may be constructed of one or more pieces, and that may be in the shape of a fish, minnow, tadpole or other desired shape. Some lures include a front and/or rear lip that may be connected to or integrally formed with the figure, and located so as to extend from one or more of any of the sides (top, bottom, left or right), or from the front and/or rear surface of the figure. Such a lip may be configured to cause the lure to dive, rise and/or wobble when the lure is pulled through the water.

It is common for such a lure to include a first connection member, such as an eyelet, for example in the form of a screw eye or the like, and/or a ring, for example in the form of a split ring or the like, which may be connected to an eyelet, at or near the front of the figure. The first connection member of a lure also may include a clasp or other fasteners or the like that together may be connected directly to the figure or to a lip that is connected to the figure, for connection to a fishing line. Lures also may include a second connection member, which may include any of the type of components mentioned for the first connection member, as well as an eye or other structure of a hook assembly. The second connection member may be located on any of the one or more sides and/or at the rear of the one or more pieces of the figure. Hook assemblies may be of one or more hook configurations including single, double and/or treble hook assemblies, with the hook assemblies typically having an eye at a proximal end of one or more shafts for connection to a connection member, and a point at a distal end of each shaft. The second connection member may be located toward the front, middle or rear of the figure. A lure also may have additional connection members, such as third and or fourth connection members, may include any of the type of components mentioned for the second connection member with additional hook assemblies, whether located near the front, middle or rear of the figure.

The depth or extent to which a crank bait lure or other buoyant lure will dive when placed in water, or will dive when pulled through water, may be controlled by several factors, including the weight of the fishing line to which the lure is connected, or weight being applied along the fishing line ahead of lure. But with respect to the construction of the lure itself, the diving or rising characteristics may be influenced by the density and weight of the figure, the inclusion of the aforementioned front and/or rear lip(s), and the size and angle of such lip(s), as well as by the connection members and whether they include one or more hook assemblies at the front, middle and/or rear of the lure.

The weight and weight distribution of the lure also may be altered or modified by connecting additional weight to the lure. Indeed, various methods have been used to add weight to lures. However, to date, such methods have tended to be difficult, time consuming, cumbersome, and may result in damage to the lure and/or risk injury to the angler. For instance, having to try to connect something to the fishing line ahead of the lure can be time consuming, require significant dexterity, such as when tying fishing line, and may cause a disadvantageous weakening of the fishing line. Alternatively, attempting to use a split ring or clasp having a positive locking feature that requires fine motor skills and manipulation between the fingers to connect a weight to a connection member on a figure may be time consuming, cumbersome and require great dexterity, while subjecting an angler to potential injury from the installation procedure, due to inadvertent contact with points or barbs on the one or more hook assemblies. In addition, drilling holes in a lure to install weights, driving screws into the lure and or otherwise seeking to attach weights to the figure and/or lip(s) of a lure, unfortunately can damage or permanently alter the lure, while subjecting the angler to potential injury from the installation procedure or due to inadvertent contact with points or barbs on the one or more hooks assemblies.

The present disclosure addresses shortcomings in prior art lure weights and methods of using lure weights to alter the performance of lures, so as to make them generally suitable for additional uses or to enhance the action of such lures. Thus, this disclosure teaches use of weights that enable enhanced performance of lures in fishing, and in some instances teaches new methods of fishing, whether during seasonal fishing to alter the action of a lure or to permit fishing in a more confined area, or using certain types of lures in ice fishing for the first time, and while providing numerous advantages over the prior art.

### SUMMARY OF THE INVENTION

The purpose and advantages of the disclosed subject matter will be set forth in and apparent from the description and drawings that follow, as well as will be learned by practice of the claimed subject matter. While the lure weights and methods of use within the present disclosure are shown with respect to particular example lures, it will be understood that the structures and principles of operation also may be utilized with alternative weight and lure constructions.

In a first aspect, the disclosure provides a lure weight comprising a body having a mass, a connector that extends from the body, and the connector having a proximal portion connected to the body and a distal portion comprising a releasable clip.

In a second aspect, the disclosure provides a method of connecting a lure weight to a lure, comprising holding a lure having a figure and having a connection member connected to the figure, holding a lure weight comprising a body and a connector that extends from the body, wherein the connector includes a distal portion comprising a releasable clip, moving the body of the lure weight so as to locate the releasable clip in a first position adjacent the connection member of the lure, and moving the body of the lure weight so as to move the releasable clip over a portion of the connection member to a second position wherein the releasable clip is connected to the connection member.

In a third aspect, the disclosure provides a method of converting a buoyant lure to a sinking lure, comprising holding a buoyant lure comprising a figure having a first connection member on a forward portion of the figure for connection to a fishing line, and a second connection member on the figure, and connecting to the second connection member a lure weight comprising a body and a connector that extends from the body and includes a distal portion comprising a releasable clip, and wherein the lure having the lure weight connected thereto sinks when placed in water.

In a fourth aspect, the disclosure provides a method of using a buoyant lure to fish within water, comprising connecting a buoyant lure to a fishing line, connecting to the lure a lure weight comprising a body and a connector that extends from the body and includes a distal portion comprising a releasable clip, putting the lure and lure weight in a body of water, letting the lure and lure weight descend a distance within the water, pulling on the fishing line a first time causing the lure and lure weight to move forward in a first direction in the water, and pulling on the fishing line at least a second time causing the lure and lure weight to move forward in a second direction in the water, wherein the second direction differs from and is generally opposed to the first direction.

In a fifth aspect, the disclosure provides a method of using a lure to fish within water, comprising connecting a lure to a fishing line, connecting to the lure a lure weight comprising a body and a connector that extends from the body and includes a distal portion comprising a releasable clip, putting the lure and lure weight in a body of water, letting the lure and lure weight descend a distance within the water, and periodically pulling on the fishing line causing the lure and lure weight to move forward in a direction in the water, wherein each pull on the fishing line causes the lure and lure weight to move forwardly in a different direction.

The disclosure provides lure weights that may include numerous advantageous aspects for use in fishing, such as, easy and quick connecting and disconnecting from a lure connection member, wherein the connection member may be any of an eyelet, a ring, an eye of a hook assembly or any other suitable or additional structure that is connected to the lure figure. This advantageously avoids potential damage to the fishing line to which the lure is connected, as well as potential injury to an angler who is able to hold the body of the lure weight, at a distance from its releasable clip when connecting the lure weight to and disconnecting the lure weight from a lure. The lure weights also may be configured to have a variety of different masses, to be able to tailor their use to a variety of different lures, depending on the desired rate of sinking the lure or the desired effect on the action of the lure when pulled and/or moving through the water. Indeed, the lure weights permit an angler to customize lures for use in new methods of fishing, thereby extending the circumstances and setting in which one may use the lures.

The present disclosure further includes examples of alternative embodiments of lure weights that highlight the fact that the inventive subject matter can be applied to fishing equipment including lures of various designs, even though the examples to which the lure weights shown herein are in the form of buoyant, diving or crank bait lures. Moreover, the lure weights may be constructed using various materials, even if easy of manufacturing may favor metallic constructions. Indeed, lure weights in accordance with the present disclosure may include various relatively high density materials for use in the body of the lure weights, while using similar or dissimilar materials for the connector that extends from the body of the lure.

It is to be understood that both the foregoing general description and the following detailed description are exemplary and provided for purposes of explanation only, and are not restrictive of the subject matter claimed. Further features and objects of the present disclosure will become more fully apparent in the following description of the preferred embodiments and from the appended claims.

### BRIEF DESCRIPTION OF THE DRAWINGS

In describing the preferred embodiments, reference is made to the accompanying drawing figures wherein like parts have like reference numerals, and wherein:

FIG. 1 is a front perspective view of a first example lure weight.

FIG. 2 is a side view of the first example lure weight shown in FIG. 1.

FIG. 3 is front view of the first example lure weight shown in FIG. 1.

FIG. 4 is a rear perspective view of the first example lure weight shown in FIG. 1.

FIG. 5 is a cross-sectional view of the first example lure weight shown in FIG. 1.

FIG. 6 is a cross-sectional view of a second example lure weight.

FIG. 7 is a front view of a third example lure weight.

FIG. 8 is side view of the third example lure weight shown in FIG. 7.

FIG. 9 is a side view of the first example lure weight of FIG. 1 connected to a connection member of a first example lure, at an eye of a front hook assembly of the lure.

FIG. 10 is a side view of the first example lure weight of FIG. 1 connected to a connection member of a second example lure, at an eye of a rear hook assembly of the lure.

FIG. 11 is a side view of the first example lure weight of FIG. 1 connected to a connection member of a third example lure, at a front eyelet of the lure.

FIG. 12 is a side view of the first example lure weight of FIG. 1 connected to a connection member of a fourth example lure, at a rear ring of the lure.

FIG. 13 is a side view of the first example lure weight of FIG. 1 connected to a connection member of a fifth example lure, at a front ring of the lure.

FIGS. 14A-14F are a series of schematic depictions of steps within a method of fishing using the first example lure and first example lure weight of FIG. 9.

It should be understood that the drawings are not to scale. While some mechanical details of example lure weights, including other plan and section views of the examples shown and of examples that may have alternative configurations, have not been included, such details are considered well within the comprehension of those of skill in the art in light of the present disclosure. It also should be understood that the present invention is not limited to the example embodiments illustrated.

### DETAILED DESCRIPTION OF THE PREFERRED EMBODIMENTS

For the following defined terms, these definitions shall be applied, unless a different definition is given in the claims or elsewhere in this disclosure. As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

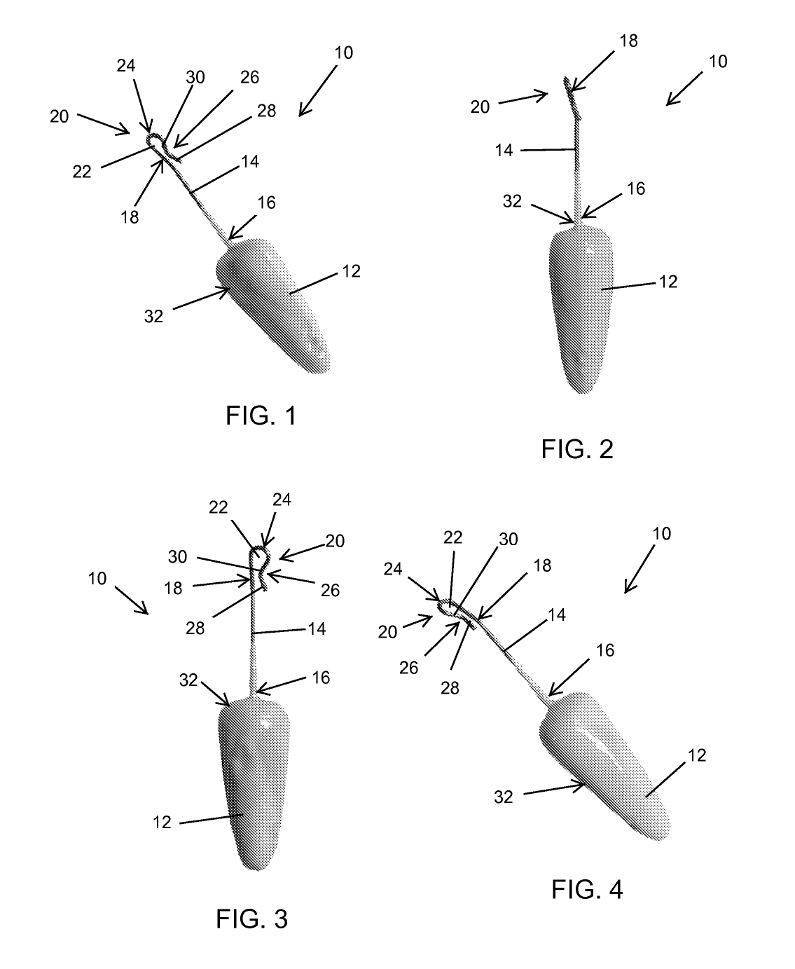

Referring generally to FIGS. 1-14F, it will be appreciated that lure weights of the present disclosure generally may be embodied within numerous configurations, and may be used in various ways to alter and enhance methods of fishing. Indeed, while acknowledging that all of the example configurations of lure weights and fishing lures to which such lure weights may be connected need not be shown herein, several examples are provided to better demonstrate that a variety of configurations and methods of use are contemplated.

Turning to a first example embodiment of a lure weight shown in FIGS. 1-5, a lure weight 10 includes a body 12 and a connector 14 that extends from the body 12. In this example, the connector 14 has a proximal portion 16 connected to the body 12 and a distal portion 18 that includes a releasable clip 20. The body 12 may be constructed of rigid or relatively rigid materials having a relatively high mass or density greater than water, so as to increase the tendency to sink in water for a lure to which the lure weight is connected. Such materials may include lead, tungsten, steel, brass or other metals, but it will be appreciated that other suitable materials may include non-metals, such as ceramics, glass, high density polymers or rubber, composite resins or even natural materials, such as stone or rock that may be drilled or molded with the use of resins, or the like. The body also may be porous, advantageously facilitating the application of a bait scent. Lure weights 10 may be configured to have different masses, and it will be appreciated that lures of different sizes and masses may benefit from use of lure weights having different sizes and masses. For instance, a larger lure having a longer hook assembly may require a heavier body and a longer connector, so that the body will preferably hang below the hooks of the hook assembly. A smaller lure, having a smaller hook assembly, may be able to use a lure weight that has a body that is not as heavy and a connector that is somewhat shorter while still allowing the body to hang below the hooks of the smaller hook assembly.

The body 12 of the example lure weight 10 shown in FIG. 1 has a top and a bottom, with the connector 14 extending from the top of the body 12. The body 12 of this example has a shape that is tapered from the top to the bottom, meaning that the top of the body 12 is broader than the bottom of the body. A lure weight of this shape also may be referred to as a “bullet weight”, which is an advantageous shape for descending in water. However, it will be appreciated that other shapes and sizes may be used.

The connector 14 that extends from the body 12 may be constructed in the form of an elongated wire, rod or strip made of a relatively rigid material that preferably has some corrosion resistance, such as stainless steel, a metal alloy, a suitable polymer or the like. Thus, the connector 14 may be constructed of a firm wire, rod or strip, but it will be understood that the releasable clip 20 of the distal portion 18 may have an opening 22 and may include a resilient portion 24. In the example shown, the releasable clip 20 further includes an entry and exit portion 26 having an entry draft angle 28 and an exit draft angle 30 that allow the connector 14 to be quickly and conveniently connected to or released from a connection member of a lure.

It will be appreciated that the entry and exit portion of the releasable clip may be located anywhere along the distal portion of the connector that extends from the body, and preferably is spaced from the body. The example connector 14 optionally may further include a bend 24 between the proximal portion 16 and distal portion 18, which as described further herein, will allow the lure weight 10 to hang from a lure and advantageously run parallel to a hook assembly in a relatively compact manner. This prevents an interference with the hook assembly that may otherwise cause the lure weight to be forced to stick out at an angle from the hook assembly, and allows the body to hang below the hook assembly.

As shown with the first example, if desired, the lure weight 10 may include a coating 32 over the body 12. The coating 32 also may cover a portion of the connector 14, and may include materials such as paint, epoxy resin or the like, whether in a clear coat, a plain continuous color or a particular design. The coating 32 may be applied for any number of desired reasons, such as for aesthetics, durability or to prevent water intrusion at the connection of the connector 14 to the body 12. The coating also may comprise a bait scent material or provide a base for application of a natural or synthetic bait scent material. Such bait scent material may be in solid or liquid form and may be applied to the lure weight 10 in any suitable manner, such as by dipping the weight in a bait scent liquid. A bait scent material also may be easily applied if the body of the lure weight is constructed of a porous material.

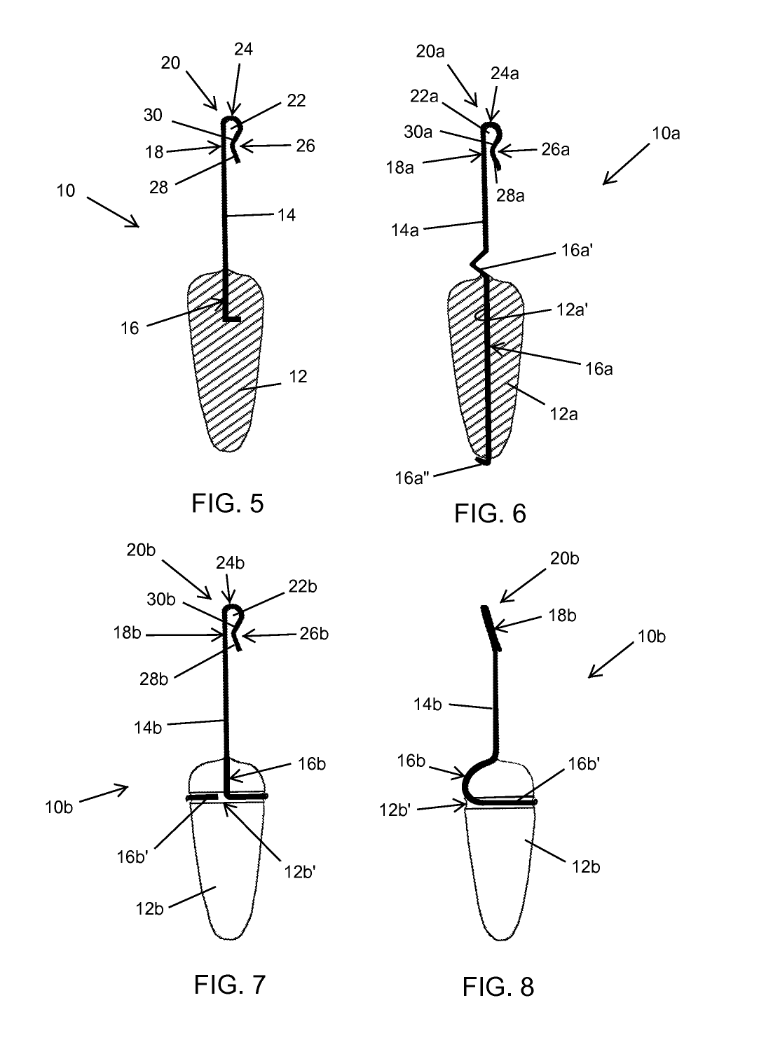

The connector also may be connected to the body of a lure weight in various ways. For instance, the first example lure weight 10, shown in FIGS. 1-5, has the proximal portion 16 of the connector 14 retained within the body 12. It will be appreciated from the cross-sectional view in FIG. 5 that the body 12 may be molded over the proximal portion 16 of the connector 14. The two components also could be connected in alternative ways, such as if the proximal portion were straight and threaded and sized to threadably engage a threaded bore at the top of the body.

A second example lure weight 10a is shown in a cross-sectional view in FIG. 6, where the lure weight 10a includes a body 12a having a passage 12a′ extending through the body 12a from the top to the bottom. A connector 14a is retained by and extends through and from the body 12a. However, in this second example, a proximal portion 16a of the connector is connected to the body 12a and includes a bend 16a′ above the top of the body 12a and a bend 16a″ at the end of the proximal portion 16a. A distal portion 18a is similar to that of the first example in that it includes a releasable clip 20a having an opening 22a and a resilient portion 24a. The releasable clip 20a also includes an entry and exit portion 26a having an entry draft angle 28a and an exit draft angle 30a. The second example lure weight 10a may include a bend between the proximal portion 16a and distal portion 18a, similarly to that of the first example lure weight 10.

A third example lure weight 10b is shown in FIGS. 7 and 8. The lure weight 10b includes a groove 12b′ around a mid-section of a body 12b. A connector 14b is retained by and extends from the body 12b by having a proximal portion 16b that includes an end 16b′ that bends outward and then around a portion of the body 12b, within the groove 12b′. The open ring formed at the end 16b′ may be slid up the body 12b until it enters and is retained by the groove 12b′. A distal portion 18b is similar to that of the first example in that it includes a releasable clip 20b having an opening 22b and a resilient portion 24b. The releasable clip 20b also includes an entry and exit portion 26b having an entry draft angle 28b and an exit draft angle 30b. The third example lure weight 10b also may include a bend between the proximal portion 16b and distal portion 18b, similarly to that of the first example lure weight 10.

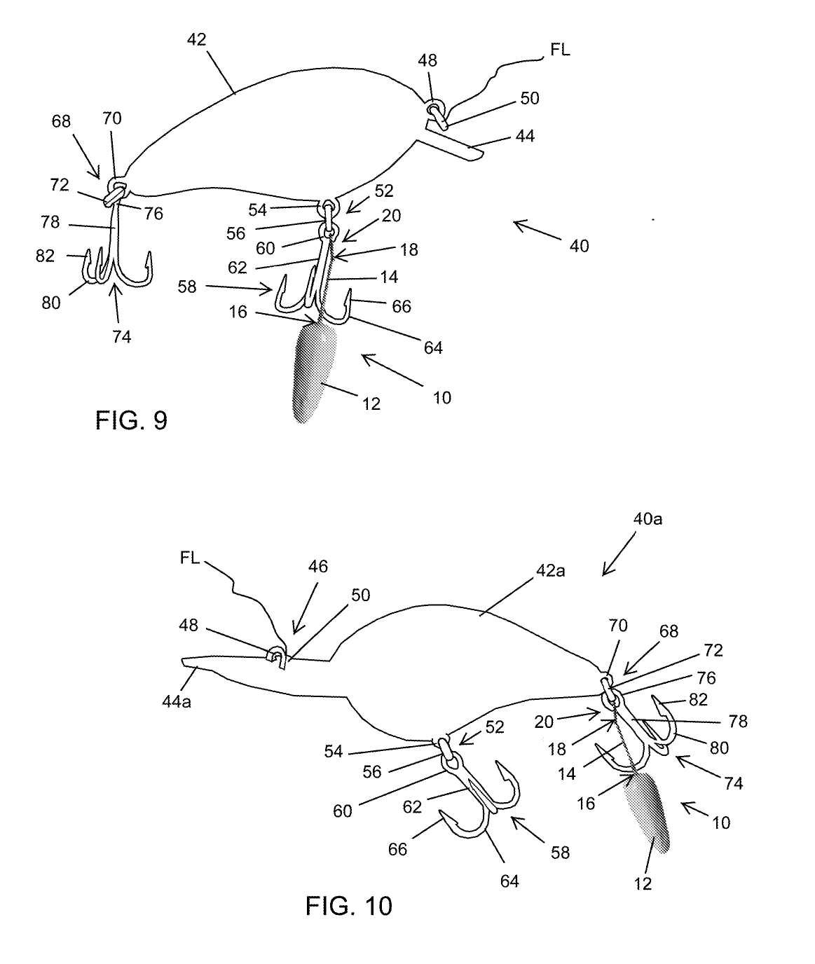

Turning now to FIGS. 9-13, which show side views of five different example lures to which are connected, in various ways, the first example lure weights 10. The first example lure 40, shown in FIG. 9, may be referred to as a buoyant lure, a diving lure or a crank bait lure, as it includes a figure or central portion 42 from which extends a lip 44 forwardly and downwardly from the front of the FIG. 42. The angle of the lip 44 will tend to make the lure 40 dive when it moves forwardly in water. In this example, a first connection member 46 includes a first eyelet 48. The first eyelet 48 may be an eyelet screw or to other fastener and may be connected to the front of the FIG. 42 in any suitable manner. In this example, the first connection member 46 further includes a ring 50, such as a split ring or the like, to which a fishing line FL may be connected, directly or via a leader or other suitable assembly, to pull the lure 40.

The lure 40 further includes a second connection member 52 that includes a second eyelet 54, which similarly may be of any suitable construction and connected to the lower side of the FIG. 42. The connection member 52 further includes a ring 56, such as a split ring or the like, which is connected to the eyelet 54, and a hook assembly 58 having an eye 60. While additional clips, clasps or other forms of fasteners may be included, the second connection member 52 of the example lure 42 effectively provides at least three structures for connection of a lure weight 10 including the second eyelet 54, ring 56 and eye 60. The hook assembly 58 of this example is provided in the form of a treble hook having at least one shaft 62 extending from the eye 60 and supporting at least one hook 64, which in this example includes three hooks 64 having points 66.

This first example lure 40 further includes a third connection member 68 that includes a third eyelet 70, which may be similar to or differ from the structures of the first and second connection members and which is connected to a rearward portion of the FIG. 42. The third connection member 68 further includes a ring 72, such as a split ring or the like, connected to the third eyelet 70, and a hook assembly 74 having an eye 76. Accordingly, while it may include additional structures, the third connection member 68 of the example lure 42 effectively provides at least three structures for connection of a lure weight 10 including the third eyelet 70, ring 72 and eye 76. The hook assembly 74 is similar to the hook assembly 58 in that it is in the form of a treble hook having at least one shaft 78 extending from the eye 76 and supporting at least one hook 80, which in this example includes three hooks 80 having points 82.

It will be appreciated from FIG. 9 that the lure weight 10 may be connected to a lure 40 using a method that includes holding a lure 40 having a FIG. 42 and having a connection member 52 connected to the FIG. 42, holding a lure weight 10 having a body 12 and a connector 14 that extends from the body, wherein the connector 14 includes a distal portion 18 having a releasable clip 20, moving the body 12 of the lure weight 10 so as to locate the releasable clip 20 in a first position adjacent the connection member 52 of the lure 42, and moving the body 12 of the lure weight 10 so as to move the releasable clip 20 over a portion of the connection member 58 to a second position wherein the releasable clip 20 is connected to the connection member 58. In the example of FIG. 9, the portion of the connection member 58 over which the releasable clip 20 is moved and to which it is releasably connected is the eye 60 of the hook assembly 58.

It will be appreciated that the configuration of the lure weight 10 allows an angler to hold the FIG. 42 of the lure 40 and to hold the body 12 of a lure weight 10 to connect the lure weight 10 to the lure 40. The angler is able to hold the body 12 and extend the relatively rigid connector 14 with its releasable clip 20 to be quickly and conveniently connected to the second connection member 52 or third connection member 68, without having to risk being injured by the hooks 64 or 80. The releasable clip 20 is configured also to be quickly and conveniently released from the connection member, again while holding the figure of the lure, such as the FIG. 42 of lure 40 or the like, and when holding the lure weight 10 only by the body 12. Indeed, the lure weight 10 has a connector 14 having an elongated wire that resists bending such that the lure weight 10 is connectable to and releasable from a lure, such as first example lure 40, when holding the lure weight 10 only by the body 12.

This disclosure further provides a method of converting a buoyant lure to a sinking lure. For example, the method includes holding a buoyant lure, such as lure 40, having a FIG. 42 having a first connection member 46 on a forward portion of the FIG. 42 for connection to a fishing line FL, and a second connection member 52 on the FIG. 42, and connecting to the second connection member 52 a lure weight 10 comprising a body 12 and a connector 14 that extends from the body 12 and includes a distal portion 18 comprising a releasable clip 20, and wherein the lure 40 having the lure weight 10 connected thereto sinks when placed in water. The method of converting a buoyant lure to a sinking lure may further include moving the body 12 of the lure weight 10 so as to locate the releasable clip 20 in a first position adjacent the second connection member 52 of the buoyant lure 40, and moving the body 12 of the lure weight 10 so as to move the releasable clip 20 over a portion of the second connection member 52 to a second position wherein the releasable clip 20 is connected to the second connection 52. It will be noted that the second connection member 52 further comprises an eyelet, a ring or an eye of a hook assembly, such as eyelet 54, ring 56, eye 60 or the like, to which the releasable clip 20 is connected. It will be appreciated that the method also may include wherein the second connection member 52 is located on a forward, middle or rear portion of the FIG. 42 of the lure 40, such as at first connection member 46, second connection member 52 or third connection member 68. Indeed, it also would be possible to connect multiple lure weights to the lure, at a single connection member or at separate connection members. By converting a buoyant lure to a sinking lure, an angler can modify the action of the lure, use the lure in different methods of fishing methods and use the lure even during ice fishing.

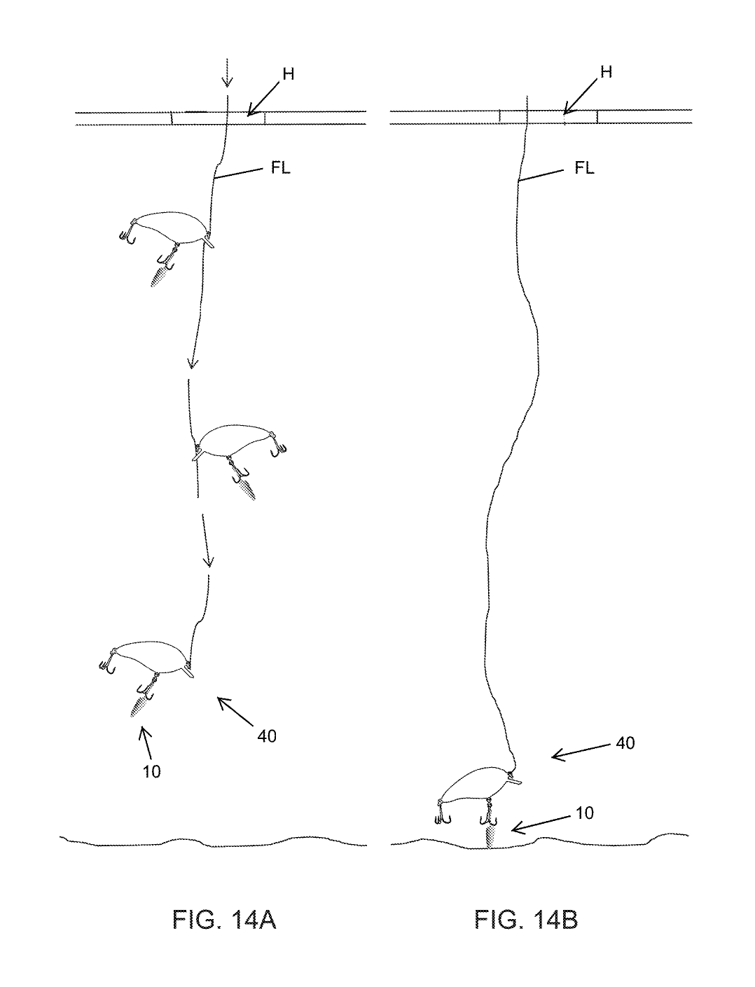

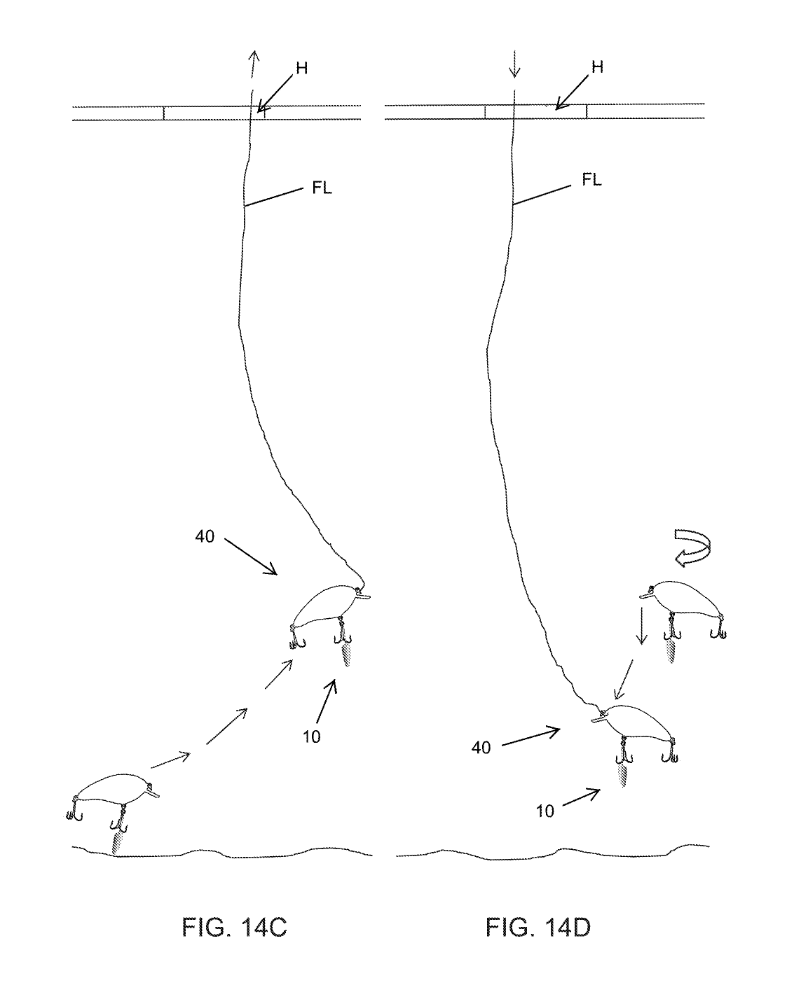

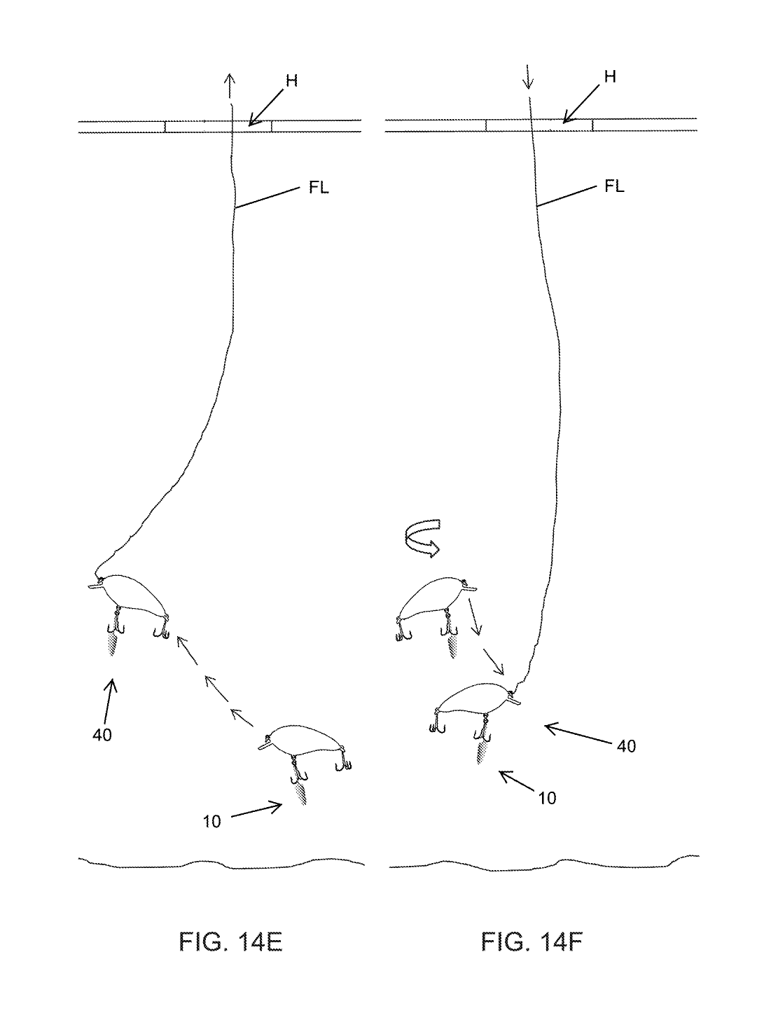

The example lure weight 10 also permits a new method of using a buoyant lure 40 to fish within water, that includes connecting a buoyant lure 40 to a fishing line FL, connecting to the lure 40 a lure weight 10 comprising a body 12 and a connector 14 which extends from the body 12 and includes a distal portion 18 having a releasable clip 20 (such as shown in FIG. 9). The method further includes putting the lure 40 and lure weight 10 in a body of water (such as through the ice fishing hole H in FIG. 14A), letting the lure 40 and lure weight 10 descend a distance within the water (shown generally in FIGS. 14A-14B), pulling on the fishing line FL a first time causing the lure 40 and lure weight 10 to move forward in a first direction in the water (shown generally in FIG. 14C), and pulling on the fishing line FL at least a second time causing the lure 40 and lure weight 10 to move forward in a second direction in the water (shown generally in FIG. 14E), wherein the second direction differs from and is generally opposed to the first direction. This method is generally schematically depicted in FIGS. 14A-14F, and it will be appreciated that when the line is relaxed after each pulling event, the line and lure will tend to turn and sink (shown generally in FIGS. 14D and 14F). It will be appreciated that within this method, the movements forward in first and second directions remain proximate or near the location that the lure 40 and lure weight 10 were permitted to descend. For instance, in FIGS. 14A-14F the fishing line passes through a hole, such as a hole H that may be drilled through ice to permit ice fishing. However, one will appreciate that the method also may be used when fishing in open water, but in a localized area, such as adjacent a boat or dock. It will be appreciated that the method also may include further movements, such as short tugs on the fishing line to make the lure wiggle, between the larger pulling motions that cause the lure to dart in a forward direction. Moreover, the pulling motions may lift the fishing line one or two feet, or as desired, while the smaller tugging motions may lift the fishing line one to a few inches, or as desired, to cause advantageous wiggle action of the lure.

The lure weight 10 further permits a method of using a lure 40 to fish within water including connecting a lure 40 to a fishing line FL, connecting to the lure 40 a lure weight 10 that includes a body 12 and a connector 14 that extends from the body and includes a distal portion 18 having a releasable clip 20. The method also includes putting the lure 40 and lure weight 10 in a body of water, letting the lure 40 and lure weight 10 descend a distance within the water (shown in FIGS. 14A-14B), and periodically pulling on the fishing line FL causing the lure 40 and lure weight 10 to move forward in a direction in the water (shown in FIGS. 14C and 14E), wherein each pull on the fishing line FL causes the lure 40 and lure weight 10 to move forwardly in a different direction. This method is somewhat similar to the previously described method, and also is depicted in FIGS. 14A-14F.

In both methods, the distance the lure 40 and lure weight 10 are permitted to descend may be a distance required to reach the bottom of the body of water at that particular location, or some lesser distance, which may be determined by a desire to fish at a particular depth. Indeed, the size or mass of the lure weight 10 that is chosen for use with a given lure may be dependent upon the desired speed at which the lure will descend. This can be determined by observation, and then applied to reach greater depths by treating the lure as a “count down” lure, wherein one can predict the depth to which a lure will sink or descend by knowing the rate at which it descends and counting for a period of time to achieve a desired depth while descending at that rate.

In addition, these methods of using a lure to fish in water within an area immediately proximate the angler include that the area of water in which the lure 40 and lure weight 10 can move in the first and second directions is defined by the distance to which the lure and lure weight descended. Thus, these particular methods are unlike casting or trolling with a lure, because when the line is pulled, the lure tends to dart somewhat upward but also forward in a first direction, typically away from the path through which the lure first descended. This may give the impression that the bait is trying to escape. Then, when the line is relaxed the lure will tend to again descend, acting somewhat like a wounded fish or minnow, and will tend to turn back toward the path through which the lure descended. Upon pulling the line again, the lure will tend to dart somewhat upward but also forward in a second direction, which will be generally opposed to the first direction, and potentially back across the path of initial descent, before again tending to turn to face another direction. With subsequent pulls the lure will continue to tend to dart in a direction, but generally be limited in terms of how far it may travel before running out of line and tending to turn back toward the initial path of descent. As noted above, it will be recognized that an angler may interject additional steps in the method, such as to wiggle the line, to increase the action of the lure, or to attempt to take up or further let out the fishing line while conducting or in between the pulling motions of the fishing line.

Further examples of lures and positions for connection of lure weights are shown in FIGS. 10-13, where like structures are numbered similarly. For instance, in FIG. 10, a second example lure 40a is of a different shape and includes a lip 44a having a different shape and extending at a different angle than the lip 44 of the lure 40, but many of the components are otherwise similar. However, in FIG. 10, the lure weight 10 is connected to the connection member 68 at the eye 70 of the hook assembly 74. It will be recognized that this may be considered a second connection member on the lure 40a, even though it is in a rear position. Notably, given the angle of the lip 44a and the location of the lure weight 10 at the rear of the lure 40a, the lure 40a is likely to move upward at a greater rate when subjected to pulling of the fishing line, relative to the likely motion or path of the first example lure 40.

This demonstrates one aspect in which an angler may “tune” the action of a given lure, depending on the size or mass of the lure weight and the location at which the lure weight is connected to the lure. Moreover, the location of the lure weight, whether forward or rearward on a lure, and the direction in which it hangs from a respective connection member also may affect the wobble or side to side motion of the lure as it moves through the water. For instances, when hanging from a rearward connection member, the rear of the lure will tend to sink. Then, if an angler is casting and retrieving the lure, use of a snap jigging motion will tend to make the lure “dance” or dart left and right, providing a different action for the lure. Also, body 12 of the lure weight 10, hanging below the bottom of a hook assembly further will tend to contact the bottom of a body of water or objects lying thereon, which may tend to help avoid hook assemblies becoming entangled by weeds or other obstructions.

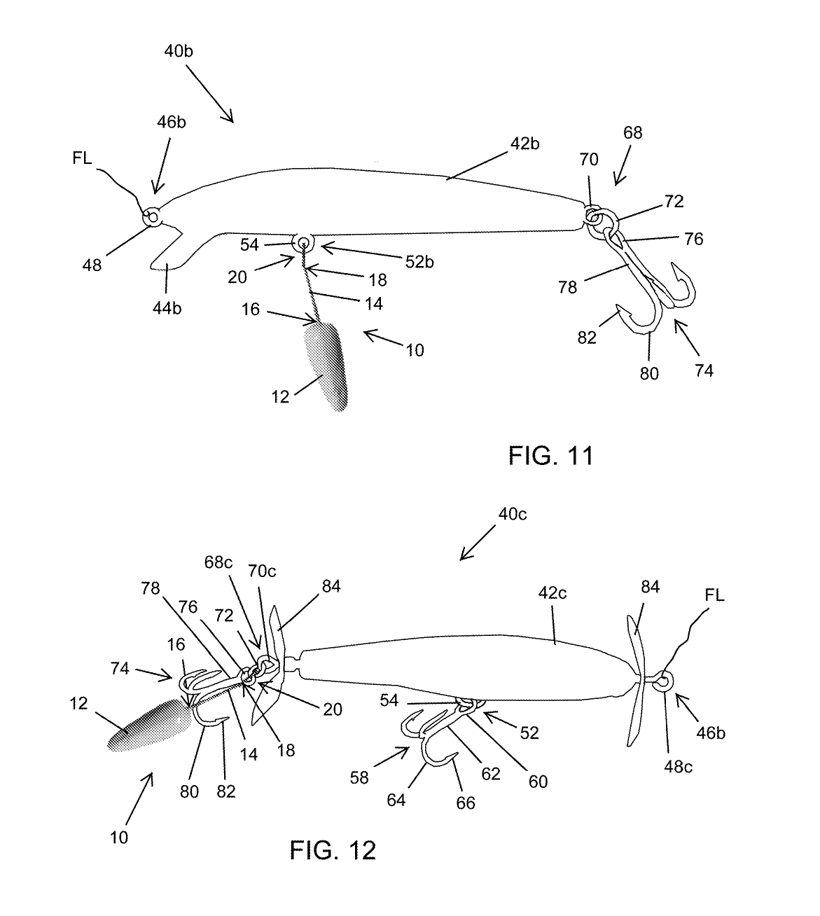

A third example lure 40b is shown in FIG. 11, where the lure 40b includes a FIG. 42b and a forward and downwardly extending lip 44b. Noticeably, the lure 40b does not include a front hook assembly, but it does have a lure weight 10 connected to the connection member 52 at the eyelet 54 along a forward portion of the bottom side of the lure 40b. This configuration of connection of a lure weight 10 on the FIG. 42b will not only allow the lure 40b to sink but also will tend to cause an increase in the extent to which the lure will move forward as opposed to upward relative to the example lures 40 and 40a. This configuration also limits the arrangement of the hook assembly to being located only at the rear of the lure.

A fourth example lure 40c is shown in FIG. 12, where the lure 40c includes a FIG. 42c but does not include a forward or rearward lip. The lure 40c does include forward and rear hook assemblies 58 and 74, and has a lure weight 10 connected to the connection member 68 at the ring 72 at the rear of the lure 40c. This connection of a lure weight 10 at the rear of the FIG. 42c and the lack of a forward and downwardly extending lip at the front of the lure will cause the lure 40c to sink or descend but also will tend to cause an increase in the extent to which the lure will move upward as opposed to forward relative to the example lures 40 and 40b. The tendency of the rear of the lure 40c to sink may provide additional action, as discussed above with respect to lure 40a shown in FIG. 10. The configuration of lure 40c also includes additional spinning elements 84 at the front and rear of the FIG. 42c which are rotatably mounted on shafts of the eyelets 48c and 70c. As such, one will appreciate that additional different assemblies may be used in conjunction with the lure weights disclosed herein.

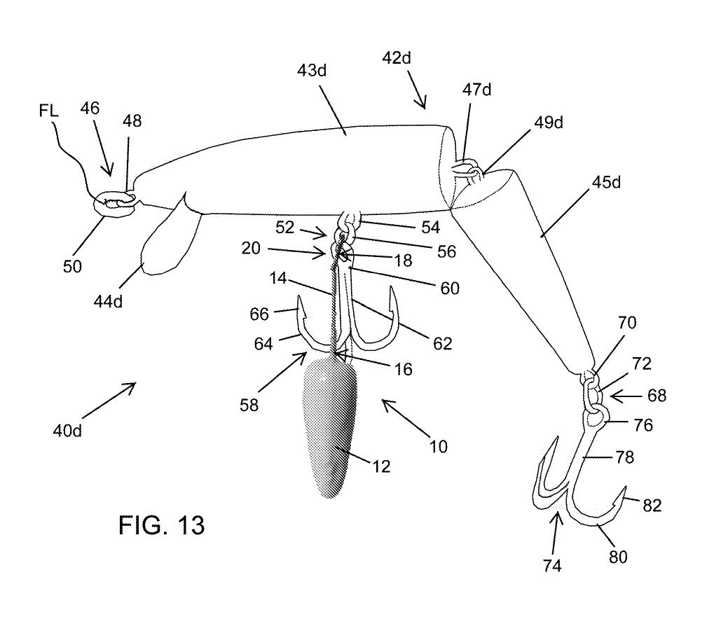

A fifth example lure 40d is shown in FIG. 13, where the lure 40d includes a FIG. 42d having a forward portion 43d and a rearward portion 45d that are connected by respective eyelets 47d and 49d. The lure 40d has a first connection member 48 for connection to a fishing line and includes a forward and downwardly extending lip 44d connected toward the front of the FIG. 42d. A lure weight 10 is connected to a second connection member 52 at a ring 56 and hangs along a shaft 62 of a forward hook assembly 58, and below the hooks 64. This configuration of a lure 40d and lure weight 10 on the FIG. 42d in FIG. 13 will allow the lure 40d to sink and will tend to cause an increase in the extent to which the lure will move forward as opposed to upward relative to the example lures 40a and 40c. The two piece FIG. 42d may provide additional lure action and is likely to have more side to side movement at the rear of the lure 40d.

Given the numerous, convenient ways in which the example lure weights 10 may be quickly, conveniently and safely connected to and disconnected from lures, it will be appreciated that an angler can now readily use buoyant lures when ice fishing or to fish in a more localized area, but also may affect the action and likely path of descent and travel of a lure even when used in methods of fishing that include casting and trolling with lures that are buoyant or that tend to sink.

From the above disclosure, it will be apparent that lure weights constructed in accordance with this disclosure may include a number of structural aspects that provide numerous advantages over conventional constructions. The example lure weights shown herein may exhibit one or more of the above-referenced potential advantages, depending upon the specific design chosen.

It will be appreciated that a lure weight constructed in accordance with the present disclosure may be provided in various configurations. Any variety of suitable materials of construction, configurations, shapes and sizes for the components and methods of connecting the components may be utilized to meet the particular needs and requirements of an end user. It will be apparent to those skilled in the art that various modifications can be made in the design and construction of such lure weights without departing from the scope or spirit of the claimed subject matter, and that the claims are not limited to the preferred embodiments illustrated herein. It also will be appreciated that the example embodiments may be shown in simplified form, so as to focus on the key components and to avoid including structures that are not necessary to the disclosure and that would over complicate the drawings.

1. A lure weight comprising:
a body having a mass;
a connector that extends from the body; and
the connector having a proximal portion connected to the body and a distal portion comprising a releasable clip.

2. The lure weight of claim 1 wherein the releasable clip is configured to be connected to and released from a lure when holding the lure weight only by the body.

3. The lure weight of claim 1 wherein the connector further comprises an elongated wire.

4. The lure weight of claim 3 wherein the elongated wire is firm.

5. The lure weight of claim 3 wherein the elongated wire includes a bend between the proximal and distal portions.

6. The lure weight of claim 1 wherein the proximal portion of the connector is retained within the body.

7. The lure weight of claim 1 wherein the proximal portion of the connector extends through the body.

8. The lure weight of claim 1 wherein the proximal portion of the connector extends around a portion of the body.

9. The lure weight of claim 1 wherein the releasable clip includes a resilient portion.

10. The lure weight of claim 1 wherein the releasable clip further comprises an opening.

11. The lure weight of claim 1 wherein the releasable clip further comprises an entry and exit portion having an entry draft angle and an exit draft angle.

12. The lure weight of claim 1 further comprising a coating over the body.

13. The lure weight of claim 1 further comprising a bait scent material applied to at least the body.

14. The lure weight of claim 1 wherein the body has a top and a bottom, the connector extending from the top of the body and the body having a shape that is tapered from the top to the bottom.

15. A method of connecting a lure weight to a lure, comprising:
holding a lure having a figure and having a connection member connected to the figure;
holding a lure weight comprising a body and a connector that extends from the body, wherein the connector includes a distal portion comprising a releasable clip;
moving the body of the lure weight so as to locate the releasable clip in a first position adjacent the connection member of the lure; and
moving the body of the lure weight so as to move the releasable clip over a portion of the connection member to a second position wherein the releasable clip is connected to the connection member.

16. The method of connecting a lure weight to a lure of claim 15 wherein the connection member further comprises an eyelet, a ring or an eye of a hook assembly.

17. A method of converting a buoyant lure to a sinking lure, comprising:
holding a buoyant lure comprising a figure having a first connection member on a forward portion of the figure for connection to a fishing line, and a second connection member on the figure; and
connecting to the second connection member a lure weight comprising a body and a connector that extends from the body and includes a distal portion comprising a releasable clip, and wherein the lure having the lure weight connected thereto sinks when placed in water.

18. The method of converting a buoyant lure to a sinking lure of claim 17, further comprising:
moving the body of the lure weight so as to locate the releasable clip in a first position adjacent the second connection member of the buoyant lure; and
moving the body of the lure weight so as to move the releasable clip over a portion of the second connection member to a second position wherein the releasable clip is connected to the second connection.

19. The method of converting a buoyant lure to a sinking lure of claim 17, wherein the second connection member further comprises an eyelet, a ring or an eye of a hook assembly.

20. The method of converting a buoyant lure to a sinking lure of claim 17, wherein the second connection member is located on a forward, middle or rear portion of the figure of the lure.
